(19) United States
(12) Patent Application Publication
(10) Pub. No.: US 2025/0245845 A1
(43) Pub. Date: Jul. 31, 2025

(54) INFRASTRUCTURE FATIGUE TRACKING USING MONOCULAR DEPTH ESTIMATION

(71) Applicant: Toyota Research Institute, Inc., Los Altos, CA (US)

(72) Inventors: Haeyeon Lee, Redwood City, CA (US); Edwardo Martinez, Fremont, CA (US); Erin A. McColl, Los Gatos, CA (US); Vitor Campagnolo Guizilini, Santa Clara, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 18/426,778

(22) Filed: Jan. 30, 2024

(51) Int. Cl. G06T 7/55; G06T 7/20; G06V 10/98

(52) U.S. Cl. CPC G06T 7/55; G06T 7/20; G06V 10/993; G06T 2207/30252

(57) ABSTRACT

Systems, methods, and other embodiments described herein relate to using monocular depth estimation to derive detailed representations of infrastructure and facilitate condition tracking and maintenance. In one embodiment, a method includes acquiring sensor data about an infrastructure element. The method includes generating depth maps from the sensor data using a depth model that performs monocular depth estimation. The method includes analyzing the depth maps to determine a condition of the infrastructure element. The method includes, responsive to determining that the condition satisfies a health threshold, modifying a maintenance recommendation for the infrastructure element. The method includes providing the maintenance recommendation.

### TECHNICAL FIELD

The subject matter described herein relates, in general, to systems and methods for tracking the condition of infrastructure and, more particularly, to using monocular depth estimation to provide detailed representations of the infrastructure that facilitates condition tracking.

### BACKGROUND

Infrastructure (e.g., bridges, buildings, etc.) is susceptible to deterioration from many different sources, including weather, repeated use, and so on. Accordingly, routine maintenance and inspection of the infrastructure is necessary to avoid premature degradation and ensure ongoing safety. For example, bridges can develop cracks near fatigue points from constant loading induced by vehicles driving over the bridge. If these cracks are not monitored and resolved, then the bridge may require more extensive repairs than what is otherwise necessary. However, inspecting such infrastructure can be a time-consuming and expensive task, especially when a government entity has a plurality of such elements to monitor. Accordingly, infrastructure is often neglected due to a lack of resources to perform inspections, thereby leading to greater expenses to resolve the neglected problems.

### SUMMARY

Example systems and methods relate to using monocular depth estimation to derive detailed representations of infrastructure and facilitate condition tracking and maintenance. As noted previously, inspecting and maintaining infrastructure is a complex task that is often neglected. This lack of maintenance is often induced by a lack of knowledge about the condition of the infrastructure due to, for example, difficulties with routinely inspecting the infrastructure, such as a lack of manpower. Accordingly, in one approach, an infrastructure system enlists crowd-sourced information collected from vehicles that observe the infrastructure using monocular cameras.

That is, as vehicles pass infrastructure, such as overpasses for bridges, sensors on the vehicles observe the infrastructure. However, this information is typically discarded beyond a localized ephemeral use in the vehicle itself. Thus, the present approach involves collecting the sensor data to facilitate ongoing inspection of the infrastructure. In one approach, the vehicle collects monocular images, which are simply images without additional modalities of information. The vehicle may communicate the images to a cloud-based resource or process the images locally. In either case, processing the images includes applying a depth model that performs monocular depth estimation to generate depth maps. The depth maps are a per-pixel representation of depth values within the image. Thus, the depth maps provide a detailed representation of the infrastructure, including conditions of the surfaces, movements, and so on.

Accordingly, the infrastructure system, in at least one approach, uses the depth maps, whether generated at the vehicle or locally, to analyze the infrastructure and identify a condition thereof. The condition of the infrastructure generally embodies a structural health as evidenced by the form and integrity of the infrastructure, including the presence of cracks, chips, etc., and the deflection of portions of the infrastructure. For example, in one approach, the infrastructure system uses the depth maps to identify fatigue points within the infrastructure. The system may identify the fatigue points by analyzing multiple different depth maps to determine where the infrastructure is deflecting (i.e., moving) and where it is not. From this, the system can identify likely locations of fatigue due to loading. The system may then focus on the fatigue points to identify cracks/chips or other general conditions indicative of a decline in the condition. In at least one arrangement, this can involve identifying an extent of the deflection and determining whether the deflection is within a defined threshold.

Moreover, the system can analyze the depth maps to determine conditions along all viewable areas of the infrastructure. This is possible because the depth maps generally provide a dense representation of depth information that, for example, provides a fine granularity of information about the surface of the infrastructure, thereby providing information about inconsistencies in the surface of the infrastructure. Accordingly, by aggregating information from different vehicles over different periods of time, the system is able to assess the condition of the infrastructure without requiring explicit manual inspections.

From the collected information about the condition, the system may further determine whether an update to a maintenance schedule is needed. That is, in one approach, the system implements a large language model (LLM) or a visual language model (VLM) that processes the determined condition and may further also process the depth maps and/or images to determine whether to update a maintenance schedule/recommendation for the infrastructure. Thus, the language model may output an explicit recommendation that the system then uses to, for example, modify the maintenance schedule, generate alerts, and/or perform other functions in support of the infrastructure. In this way, the infrastructure system facilitates the inspection and maintenance of infrastructure by crowd-sourcing monocular images and using depth estimation to provide detailed information about the infrastructure.

In one embodiment, a infrastructure system is disclosed. The infrastructure system includes one or more processors and a memory communicably coupled to the one or more processors. The memory stores instructions that, when executed by the one or more processors, cause the one or more processors to acquire sensor data about an infrastructure element. The instructions include instructions to generate depth maps from the sensor data using a depth model that performs monocular depth estimation. The instructions include instructions to analyze the depth maps to determine a condition of the infrastructure element. The instructions include instructions to, responsive to determining that the condition satisfies a health threshold, modify a maintenance recommendation for the infrastructure element. The instructions include instructions to provide the maintenance recommendation.

In one embodiment, a non-transitory computer-readable medium including instructions that, when executed by one or more processors, cause the one or more processors to perform various functions is disclosed. The instructions include instructions to acquire sensor data about an infrastructure element. The instructions include instructions to generate depth maps from the sensor data using a depth model that performs monocular depth estimation. The instructions include instructions to analyze the depth maps to determine a condition of the infrastructure element. The instructions include instructions to, responsive to determining that the condition satisfies a health threshold, modify a maintenance recommendation for the infrastructure element. The instructions include instructions to provide the maintenance recommendation.

In one embodiment, a method is disclosed. In one embodiment, the method includes acquiring sensor data about an infrastructure element. The method includes generating depth maps from the sensor data using a depth model that performs monocular depth estimation. The method includes analyzing the depth maps to determine a condition of the infrastructure element. The method includes, responsive to determining that the condition satisfies a health threshold, modifying a maintenance recommendation for the infrastructure element. The method includes providing the maintenance recommendation.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of an infrastructure system that is associated with monitoring infrastructure using depth maps.

FIG. 3 illustrates one embodiment of a depth model that infers depth from a monocular image.

FIG. 4 illustrates one example of a cloud-computing environment in which systems and methods may operate.

FIG. 5 is a flowchart illustrating one embodiment of a method for using monocular depth estimation to facilitate monitoring infrastructure.

FIG. 6 shows one example of infrastructure monitored by a passing vehicle.

### DETAILED DESCRIPTION

Systems, methods, and other embodiments associated with using monocular depth estimation to derive detailed representations of infrastructure and facilitate condition tracking and maintenance are disclosed. As noted previously, inspecting and maintaining infrastructure is a complex task that is often neglected. This lack of maintenance is often induced by a lack of knowledge about the condition of the infrastructure due to, for example, difficulties with routinely inspecting the infrastructure, such as a lack of manpower. Accordingly, in one approach, an infrastructure system enlists crowd-sourced information collected from vehicles that observe the infrastructure using monocular cameras.

That is, as vehicles pass infrastructure, such as overpasses for bridges, sensors on the vehicles observe the infrastructure. However, this information is typically discarded beyond a localized ephemeral use in the vehicle itself. Thus, the present approach involves collecting the sensor data to facilitate ongoing inspection of the infrastructure. In one approach, the vehicle collects monocular images, which are simply images without additional modalities of information. The vehicle may communicate the images to a cloud-based resource or process the images locally. In either case, processing the images includes applying a depth model that performs monocular depth estimation to generate depth maps. The depth maps are a per-pixel representation of depth values within the image. Thus, the depth maps provide a detailed representation of the infrastructure, including conditions of the surfaces, movements, and so on.

Accordingly, the infrastructure system, in at least one approach, uses the depth maps, whether generated at the vehicle or locally, to analyze the infrastructure and identify a condition thereof. The condition of the infrastructure generally embodies a structural health as evidenced by the form and integrity of the infrastructure, including the presence of cracks, chips, etc., and the deflection of portions of the infrastructure. For example, in one approach, the infrastructure system uses the depth maps to identify fatigue points within the infrastructure. The system may identify the fatigue points by analyzing multiple different depth maps to determine where the infrastructure is deflecting (i.e., moving) and where it is not. From this, the system can identify likely locations of fatigue due to loading. The system may then focus on the fatigue points to identify cracks/chips or other general conditions indicative of a decline in the condition. In at least one arrangement, this can involve identifying an extent of the deflection and determining whether the deflection is within a defined threshold.

Moreover, the system can analyze the depth maps to determine conditions along all viewable areas of the infrastructure. This is possible because the depth maps generally provide a dense representation of depth information that, for example, provides a fine granularity of information about the surface of the infrastructure, thereby providing information about inconsistencies in the surface of the infrastructure. Accordingly, by aggregating information from different vehicles over different periods of time, the system is able to assess the condition of the infrastructure without requiring explicit manual inspections.

From the collected information about the condition, the system may further determine whether an update to a maintenance schedule is needed. That is, in one approach, the system implements a large language model (LLM) or a visual language model (VLM) that processes the determined condition and may further also process the depth maps and/or images to determine whether to update a maintenance schedule/recommendation for the infrastructure. Thus, the language model may output an explicit recommendation that the system then uses to, for example, modify the maintenance schedule, generate alerts, and/or perform other functions in support of the infrastructure. In this way, the infrastructure system facilitates the inspection and maintenance of infrastructure by crowd-sourcing monocular images and using depth estimation to provide detailed information about the infrastructure.

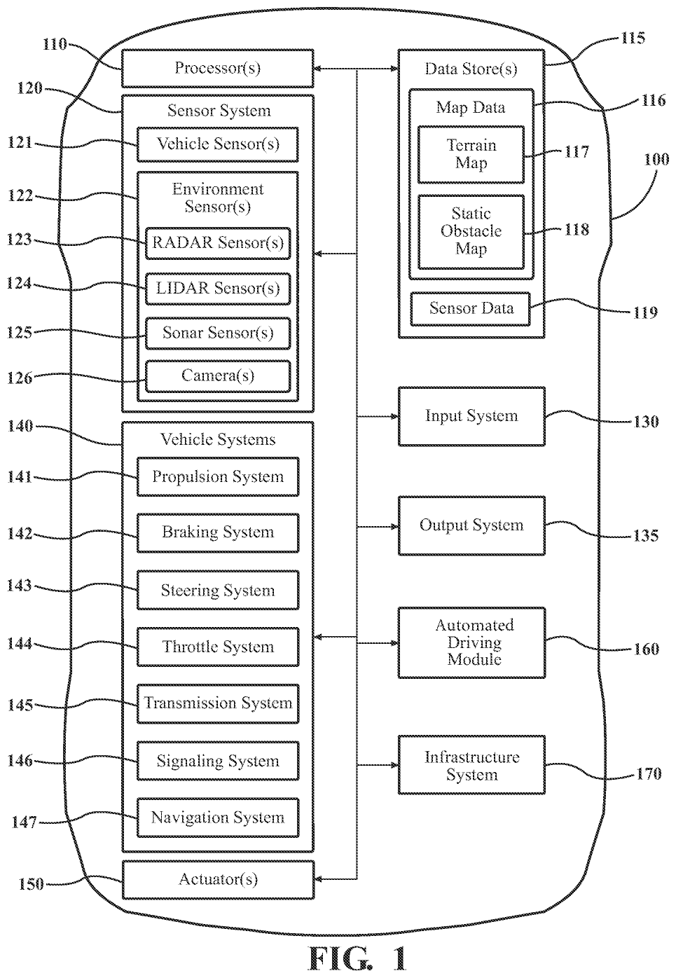

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any electronic device (e.g., smartphone, surveillance camera, robot, etc.) that, for example, perceives an environment according to images, and thus benefits from the functionality discussed herein. In yet further embodiments, the vehicle 100 may instead be a statically mounted device, an embedded device, or another device that uses images to perceive an environment.

In any case, the vehicle 100 (or another electronic device) also includes various elements. It will be understood that, in various embodiments, it may not be necessary for the vehicle 100 to have all of the elements shown in FIG. 1. The vehicle 100 can have a different combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are illustrated as being located within the vehicle 100, it will be understood that one or more of these elements can be located external to the vehicle 100. Further, the elements shown may be physically separated by large distances and provided as remote services (e.g., cloud-computing services, software-as-a-service (SaaS), distributed computing services, etc.).

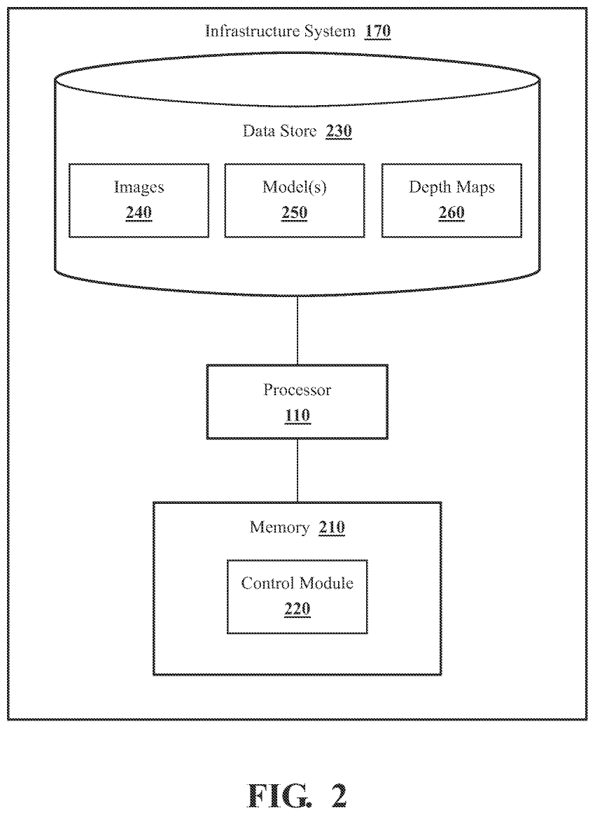

Some of the possible elements of the vehicle 100 are shown in FIG. 1 and will be described along with subsequent figures. However, a description of many of the elements in FIG. 1 will be provided after the discussion of FIGS. 2-6 for purposes of the brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

In any case, the vehicle 100 includes an infrastructure system 170 that functions to at least acquire monocular images and may further process the images to provide depth estimates in the form of depth maps. It should be noted that while the infrastructure system 170 is depicted within the vehicle 100, this instance may be a client instance that functions to perform one or more of the noted functions, such as collecting monocular images and communicating the monocular images to a server/cloud instance of the system 170 for further processing. Moreover, while depicted as a standalone component, in one or more embodiments, the infrastructure system 170 is integrated with the automated driving module 160, the camera 126, or another component of the vehicle 100. The noted functions and methods will become more apparent with a further discussion of the figures.

With reference to FIG. 2, one embodiment of the infrastructure system 170 is further illustrated. The infrastructure system 170 is shown as including a processor 110. Accordingly, the processor 110 may be a part of the infrastructure system 170 or the infrastructure system 170 may access the processor 110 through a data bus or another communication path. In one or more embodiments, the processor 110 is an application-specific integrated circuit (ASIC) that is configured to implement functions associated with a control module 220. In general, the processor 110 is an electronic processor, such as a microprocessor, that is capable of performing various functions, as described herein. In one embodiment, the infrastructure system 170 includes a memory 210 that stores the control module 220. The memory 210 is a random-access memory (RAM), read-only memory (ROM), a hard disk drive, a flash memory, or other suitable memory for storing the control module 220. The control module 220 is, for example, computer-readable instructions that, when executed by the processor 110, cause the processor 110 to perform the various functions disclosed herein.

Furthermore, in one embodiment, the infrastructure system 170 includes a data store 230. The data store 230 is, in one embodiment, an electronic data structure, such as a database, that is stored in the memory 210 or another memory, and that is configured with routines that can be executed by the processor 110 for analyzing stored data, providing stored data, organizing stored data, and so on. Thus, in one embodiment, the data store 230 stores data used by the control module 220 in executing various functions. In one embodiment, the data store 230 includes images 240, models 250, which may include a depth model, and/or a language model, and depth maps 260 along with, for example, other information that is used by the control module 220.

It should be appreciated that the models 250 are, for example, machine learning models. As such, the infrastructure system 170 or another system function to train the models 250 using training data. It should be noted that the models 250 are first trained on a particular task (e.g., monocular depth estimation) as a pre-configuration step and then used during inference to perform the task. Accordingly, the form of the input data may vary according to the type of training as compared to inference.

In any case, as described herein, the images 240 are monocular images. A monocular image is, for example, an image from the camera 126, or another monocular camera, that may be part of a video, and that encompasses a field-of-view (FOV) about the vehicle 100 of at least a portion of the surrounding environment. That is, the monocular image is, in one approach, generally limited to a subregion of the surrounding environment. As such, the image may be of a forward-facing (i.e., the direction of travel) 60, 90, 120-degree fOV, a rear/side-facing FOV, or some other subregion as defined by the characteristics of the camera 126.

The monocular image itself includes visual data of the FOV that is encoded according to a video/image standard (e.g., codec) associated with the camera 126. In general, the characteristics of the camera 126 and a video/image standard define a format of the monocular image. Thus, while the particular characteristics can vary according to different implementations, in general, the image has a defined resolution (i.e., height and width in pixels) and format. Thus, for example, the monocular image is generally an RGB visible light image. Whichever format that the infrastructure system 170 implements, the images 240 are monocular images in that there is no explicit additional modality indicating depth nor an explicit corresponding image from another camera from which the depth can be derived (i.e., no stereo camera pair). In contrast to a stereo image that may integrate left and right images from separate cameras mounted to generate an overlapping FOV to provide an additional depth channel, the monocular image does not include explicit depth information, such as disparity maps derived from comparing the stereo images pixel-by-pixel. Instead, the monocular image implicitly provides depth information in the relationships of perspective and a size of elements depicted therein from which the depth model derives the depth maps.

With further reference to FIG. 2, the models 250 include the depth model that produces the depth maps 260, and, in at least one approach, a language model. The language model and the depth model are, in one embodiment, machine learning algorithms. However, the particular form of the models 250 may be generally distinct. That is, for example, the depth model is a machine learning algorithm that accepts an electronic input in the form of a single monocular image and produces a depth map as a result of processing the monocular image. The exact form of the depth model may vary according to the implementation, but is generally a convolutional encoder-decoder type of neural network.

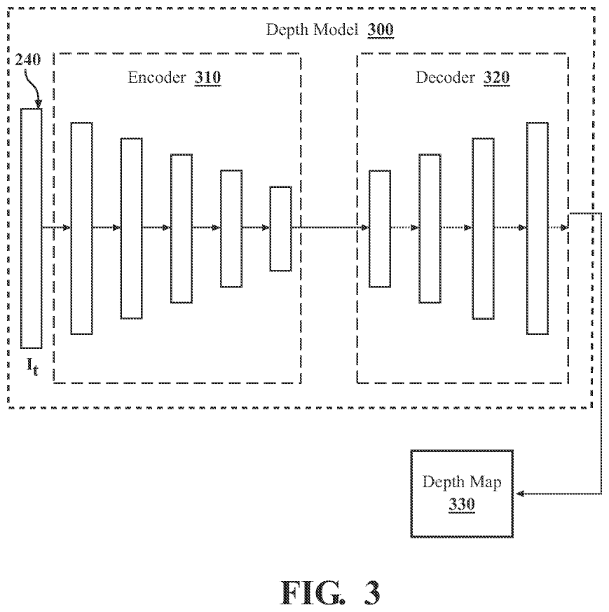

As an additional explanation of one embodiment of the depth model, consider FIG. 3. FIG. 3 illustrates a detailed view of a depth model 300. In one embodiment, the depth model 300 has an encoder/decoder architecture. The encoder/decoder architecture generally includes a set of neural network layers, including convolutional components embodied as an encoder 310 (e.g., 2D and/or 3D convolutional layers forming an encoder) that flow into deconvolutional components embodied as a decoder 320 (e.g., 2D and/or 3D deconvolutional layers forming a decoder). In one approach, the encoder 310 accepts one of the images 240 at a time as an electronic input and processes the image to extract features therefrom. The features are, in general, aspects of the image that are indicative of spatial information that the image intrinsically encodes. As such, encoding layers that form the encoder function to, for example, fold (i.e., adapt dimensions of the feature map to retain the features) encoded features into separate channels, iteratively reducing spatial dimensions of the image while packing additional channels with information about embedded states of the features. Thus, the addition of the extra channels avoids the lossy nature of the encoding process and facilitates the preservation of more information (e.g., feature details) about the original monocular image.

Accordingly, in one embodiment, the encoder 310 is comprised of multiple encoding layers formed from a combination of two-dimensional (2D) convolutional layers, packing blocks, and residual blocks. Moreover, the separate encoding layers generate outputs in the form of encoded feature maps (also referred to as tensors), which the encoding layers provide to subsequent layers in the depth model 300. As such, the encoder 310 includes a variety of separate layers that operate on the monocular image, and subsequently on derived/intermediate feature maps that convert the visual information of the monocular image into embedded state information in the form of encoded features of different channels.

In one embodiment, the decoder 320 unfolds (i.e., adapts dimensions of the tensor to extract the features) the previously encoded spatial information in order to derive the depth map 330 for a given image according to learned correlations associated with the encoded features. That is, the decoding layers generally function to up-sample, through sub-pixel convolutions and/or other mechanisms, the previously encoded features into the depth map 330, which may be provided at different resolutions. In one embodiment, the decoding layers comprise unpacking blocks, two-dimensional convolutional layers, and inverse depth layers that function as output layers for different scales of the feature map. The depth map 330 is, in one embodiment, a data structure corresponding to the input image that indicates distances/depths to objects/features represented therein. Additionally, in one embodiment, the depth map 330 is a tensor with separate data values indicating depths for corresponding locations in the image on a per-pixel basis.

Moreover, the depth model 300 can further include skip connections for providing residual information between the encoder 310 and the decoder 320 to facilitate memory of higher-level features between the separate components. While a particular encoder/decoder architecture is discussed, as previously noted, the depth model 300, in various approaches, may take different forms and generally functions to process the monocular images and provide depth maps that are per-pixel estimates about distances of objects/features depicted in the images. Moreover, while not discussed in detail herein, it should be noted that the depth model 300 may be trained according to a self-supervised structure-from-motion (SfM) process that involves using a monocular video as opposed to explicitly annotated information.

While not separately illustrated, reference will now be provided to the language model. The language model is, in at least one approach, a large language model (LLM). The LLM is a deep learning algorithm that performs natural language processing (NLP) tasks, which may be in combination with other tasks. The LLM may be formed from a transformer neural network, such as a generative pre-trained transformer (GPT). In general, the language model accepts at least condition information about infrastructure, which may be provided in the form of textual descriptions to which the language model provides a textual description as an answer. In further arrangements, the language model may be a visual language model (VLM), which accepts visual data, such as an image, a depth map, etc. in addition to the textual description. In any case, the language model generally functions to assess the condition of the infrastructure in relation to a maintenance schedule/plan and provide suggestions/alerts in regarding to maintaining the infrastructure.

As an additional note, while the models 250 are discussed as discrete units separate from the control module 220, the models 250 are, in one or more arrangements, generally integrated, at least in part, with the control module 220. That is, the control module 220 functions to execute various processes of the models 250 and uses various data structures of the models 250 in support of such execution. Accordingly, in one embodiment, the control module 220 includes instructions that function to control the processor 110 to generate the outputs using the models 250.

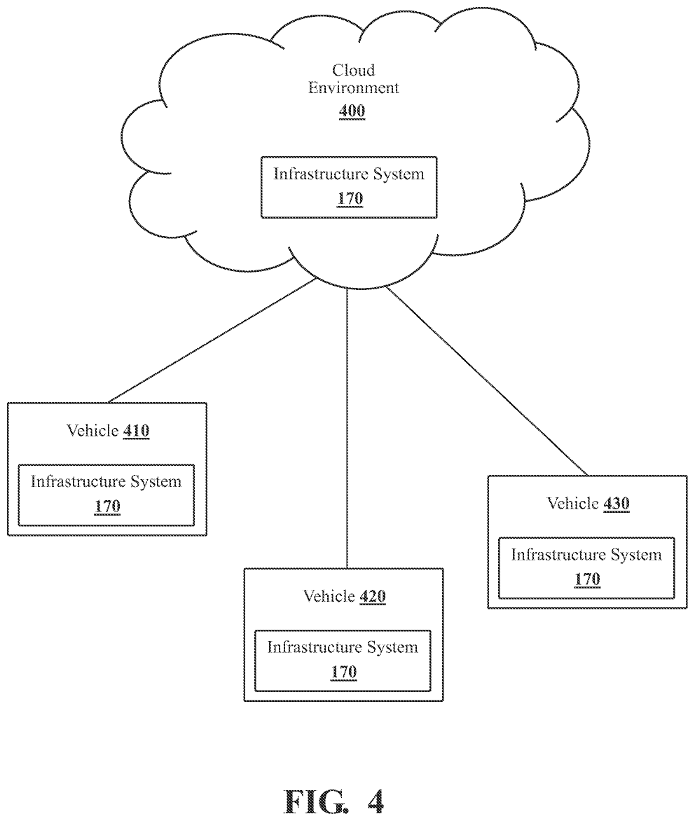

The infrastructure system 170, as illustrated in FIG. 4, is generally an abstracted form of the infrastructure system 170 as may be implemented between the vehicle 100 and a cloud-computing environment. FIG. 4 illustrates one example of a cloud-computing environment 400 that may be implemented along with the infrastructure system 170. As illustrated in FIG. 4, the infrastructure system 170 is embodied at least in part within the cloud-computing environment 400. In one or more approaches, the cloud environment 400 may facilitate communications between multiple different vehicles to acquire and distribute information between vehicles 410, 420, and 430, such as acquiring the images 240 and/or the depth maps 260.

Accordingly, as shown, the infrastructure system 170 may include separate instances within one or more entities of the cloud-based environment 400, such as servers, and also instances within vehicles that function cooperatively to acquire, analyze, and distribute the noted information. In a further aspect, the entities that implement the infrastructure system 170 within the cloud-based environment 400 may vary beyond transportation-related devices and encompass mobile devices (e.g., smartphones), and other devices that may be carried by an individual within a vehicle, and thereby can function in cooperation with the vehicle 100. Thus, the set of entities that function in coordination with the cloud environment 400 may be varied.

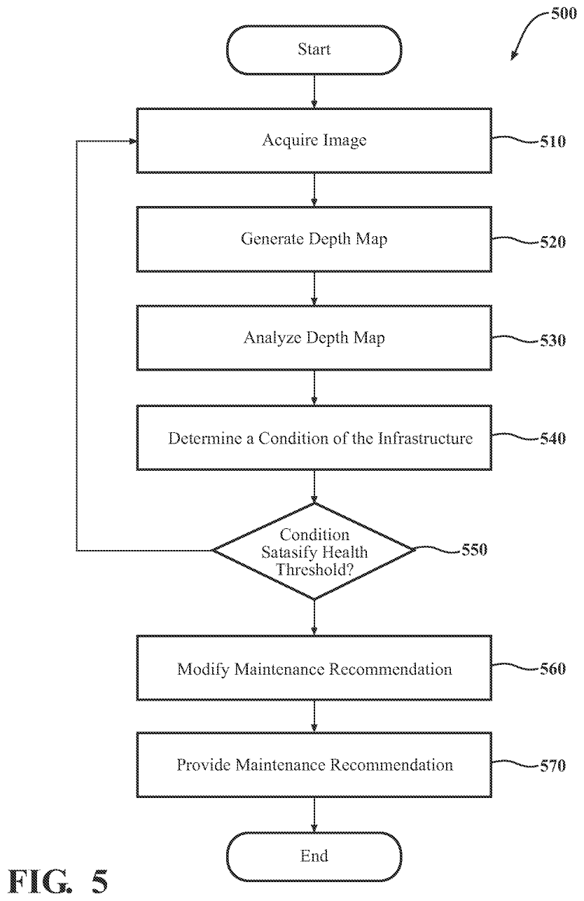

FIG. 5 illustrates a flowchart of a method 500 that is associated with using a depth model to facilitate analysis of infrastructure. Method 500 will be discussed from the perspective of the infrastructure system 170. While method 500 is discussed in combination with the infrastructure system 170, it should be appreciated that the method 500 is not limited to being implemented within the infrastructure system 170 but is instead one example of a system that may implement the method 500.

At 510, the control module 220 acquires the images 240. In one approach, while the vehicle 100 is operating in an environment, the control module 220 is capturing the images 240, which the infrastructure system 170 can then process according to the method 500. That is, depending on the particular configuration of the infrastructure system 170, the instance of the infrastructure system 170 within the vehicle 100 itself may acquire, store, and process the images 240 locally. Alternatively, the cloud-based instance of the system 170 acquires the images 240 and/or depth maps derived from the images 240 from vehicles in the environment that traverse an area of the infrastructure. Accordingly, instead of processing the images 240 locally, the vehicle 100 may, in further arrangements, offload the acquired images to the cloud-based instance.

The vehicle 100 may provide the images to the cloud in various ways depending on the particular implementation. For example, in one arrangement, the vehicle 100 communicates the images 240 to the cloud upon initial acquisition by using a cellular or other wireless communication link. In a further example, the vehicle 100 may collect the image 240 and subsequently offload the images to the cloud when connected to a local network upon parking at a residence of an owner. In yet a further example, the vehicle 100 may communicate the images 240 directly to a device located at the infrastructure via a communication link with the device, such as via Bluetooth, Wi-Fi, v2x, or another communication standard.

In any case, the cloud-based instance of the infrastructure system 170 generally acquires the images 240 from different vehicles as the vehicles traverse an area of the infrastructure and cameras of the vehicles have the infrastructure within a FoV. Moreover, because the vehicles may traverse any given environment in different ways (i.e., directions, variations in trajectories, etc.), the images 240 include many different views of the infrastructure, thereby providing a comprehensive set of information about the infrastructure that is updated with each subsequent acquisition.

As a further matter, the vehicles may be induced to provide the images 240. That is, in one or more arrangements, the infrastructure, via the noted communication device, may broadcast a beacon or other message that causes the vehicles within a defined proximity of the infrastructure to provide the images 240. In still further arrangements, the infrastructure may display a code (e.g., a QR code) or other visual indicator that, when observed by the vehicles, induces the vehicles to acquire and communicate the images. While broadly discussed, it should be appreciated that this approach to crowdsourcing the images 240 from vehicles and/or other capable devices that view the infrastructure may involve additional complexities in different arrangements, such as requiring users to opt-in to provide the images 240, compensating owners of the vehicles/devices for providing the images 240, and so on. In any case, the images 240 function as a source of information about a condition of the infrastructure that the infrastructure system 170 can then leverage.

At 520, the control module 220 generates depth maps 260 from the images 240 using the depth model to perform monocular depth estimation. In one approach, the control module 220 applies the depth model to the images 240 separately to derive the depth maps. In general, a depth map provides a pixel-wise estimation of depth values within a scene depicted by an image. This includes distances from the camera sensor to various objects depicted in the image, such as vehicles, buildings, road surfaces, trees, people, and so on. In general, the depth map provides depth information at a granularity of the pixel. Accordingly, the depth map includes corresponding depth values for separate pixels in the image. As such, the level of detail in the depth map relates to the resolution of the original image. Consequently, the depth maps 260 derived from the images 240 are generally highly detailed and provide information about surface conditions, cracks, movements/deflections, and other observable aspects of the infrastructure. As an additional note, in at least one configuration, the cloud-based instance of the system 170 may receive the depth maps from remote devices that perform the processing locally on the images. Thus, instead of providing the images 240, a vehicle may instead provide the depth map itself. In still further aspects where the vehicle performs local processing, the vehicle may provide the depth map and the image. Whichever approach is undertaken, the infrastructure system 170 aggregates the depth maps 260 and uses the detailed information of the depth maps 260 to assess the condition of the infrastructure, as discussed further subsequently.

At 530, the control module 220 analyzes the depth maps 260 to determine a condition of the infrastructure. As an initial consideration about analyzing the depth maps 260, it should be noted that the particular form of the analysis may vary depending on the implementation. For example, in one or more approaches, the system 170 implements a heuristic to analyze the depth maps via a process of directly comparing the depth maps 260. The control module 220 may identify depth maps 260 from similar viewpoints and/or may adapt the depth maps into a 3D representation in order to provide a common align-able form for comparison. The control module 220 can then directly compare information between separate acquisitions and prior known conditions to identify a current condition.

In at least one approach, the system 170 analyzes the infrastructure by identifying fatigue points within the infrastructure. For example, the control module 220 may identify areas of movement/deflection within the various members of the infrastructure, such as supports. From this information, the control module 220 can then identify fatigue points. The fatigue points may be locations that exhibit a greatest amount of observed deflection and/or areas of static loading that support deflecting members. For example, for a beam supporting a roadway of a bridge in a longitudinal direction, fatigue points that are of greatest concern may be a center of a span and a supported section resting on a pier where connections/gussets exist. These locations may be most susceptible to degradation. These same points may also correspond with deflection or other stresses from a process of loading when, for example vehicles traverse the bridge. Thus, the control module 220 can use the identified movement to determine which points are likely fatigue points that are associated with increased stresses. The control module 220 can then assess aspects, such as an extent of deflection, to provide a direct indication of whether the deflection is within an acceptable threshold range or not. In further aspects, the control module 220 may also identify the fatigue points in order to further focus the analysis of the condition on those points, such as by analyzing the fatigue points more closely for cracking and other conditions.

Overall, the control module 220 analyzes the depth maps 260 to identify characteristics of the infrastructure, including the presence of cracks, a size of cracks (e.g., length and width), chipping/spalling, rusting, paint flaking, and other damage. The control module 220 determines the various characteristics from the depth maps 260 that are generally of a similar time. For example, the control module 220 may use the depth maps 260 that are from a same 24-hour period. While a specific timeframe is provided, it should be appreciated that in further approaches, the control module 220 may instead use different conditions or timeframes. For example, the control module 220 may reassess the depth maps 260 whenever received. Alternatively, the control module 220 may reassess the depth maps 260 when at least a certain number have been received or when depth maps of certain areas have been received, such as of known areas of degradation. In any case, sourcing the images 240 from different vehicles provides for accruing more information about the infrastructure that can be analyzed at a desired rate in order to improve monitoring of the infrastructure.

At 540, the control module 220 determines the condition of the infrastructure. In general, the determination of the condition may vary in form depending on the implementation. For example, the control module 220 may provide an indicator about a general condition, such as a binary determination specifying a need for further inspection or does not need further inspection. In further examples, the control module 220 may provide a greater specificity of the condition in order to indicate, for example, precise fatigue points, cracks, or other issues relating to the overall condition. Accordingly, to determine the condition, in at least one approach, the control module 220 determines whether the fatigue points exhibit a degradation of the condition, whether cracks have increased since a prior inspection, whether new conditions (e.g., rust, etc.) are present, and so on. In general, the determination of the condition is an objective determination in relation to a prior known state and defined thresholds. The prior known state includes a previous determination of the condition, which may specify aspects, such as sizes of cracks, the presence of rust, and a size of the rusty area, etc. Thus, the control module 220 may compare the current characteristics of different aspects with the prior known state/condition to determine if there is degradation of the infrastructure.

In further examples, the control module 220 applies the defined thresholds in comparison against the identified characteristics. The thresholds may specify a size (e.g., length and width) of a crack that indicates degradation of the infrastructure, a change in a size of a crack, a change in spalling/rust, etc. Thus, the control module 220 uses the determined characteristics to define the condition either objectively or in relation to a prior known state/condition. As noted previously, the condition itself may be a binary indicator specifying the presence of degradation or may include additional detail, such as an extent of degradation, locations, types, etc.

In yet further approaches, the control module 220, instead of implementing a heuristic approach, as described above, may implement a machine learning model to generate the condition. In such an implementation, the ML model is trained to use the depth maps 260 as inputs and output the condition. Thus, the ML model may be a visual language model (VLM) or another type of model that accepts visual data as an input and outputs the condition. In both cases, the depth maps 260 provide an information rich source that portrays the condition of the infrastructure.

At 550, the control module 220 determines whether the condition satisfies a health threshold. The health threshold defines aspects of the condition that, either in isolation or when combined with the condition overall, warrant a modification of a maintenance recommendation. By way of example, the health threshold may define the presence of a new crack, a crack that exceeds a defined threshold, a change in the condition since a prior observation, and/or other characteristics as aspects of the condition that warrant modification. Thus, when the control module 220 determines that the condition satisfies the health threshold, the control module 220 proceeds to modify the maintenance recommendation, as discussed at 560. Otherwise, the control module 220 continues with acquiring images and analyzing the condition of the infrastructure.

At 560, the control module 220 modifies a maintenance recommendation for the infrastructure element. In general, the control module 220 modifies the maintenance recommendation by adjusting one or more maintenance tasks for the infrastructure. The maintenance tasks can include scheduled inspections, repair of the infrastructure, routine maintenance, emergency maintenance, and so on. Thus, the control module 220 adapts the maintenance recommendation according to changes in the condition. In general, this may involve adjusting timelines and/or adding/adapting tasks to account for the condition. Moreover, the control module 220 may provide focused and/or general maintenance recommendations depending on the condition, such as adding an inspection item for a newly identified or changed crack. In at least one approach, the control module 220 implements a large language model (LLM) for modifying the maintenance recommendation. That is, the control module 220 may use the LLM, which has been trained to correlate the condition with maintenance tasks, to generate the modifications to the maintenance recommendation. As such, the LLM takes the condition as input and outputs the recommendation as a textual description.

At 570, the control module 220 provides the maintenance recommendation. In one or more arrangements, the control module 220 provides the maintenance recommendation by generating an alert to one or more entities that manage the infrastructure about the changes in the maintenance recommendation. In further approaches, the control module 220 directly controls signs and/or other elements associated with the infrastructure. For example, in the case of infrastructure that is signalized or gated, the control module 220 may close the infrastructure until further inspection/repair or may limit use in order to avoid further damaging the infrastructure. In any case, the infrastructure system 170 leverages the pervasive nature of vehicles with cameras to collect useful information about infrastructure and further processes the information into the depth maps that provide detailed information about the condition in order to improve monitoring and maintenance of the infrastructure.

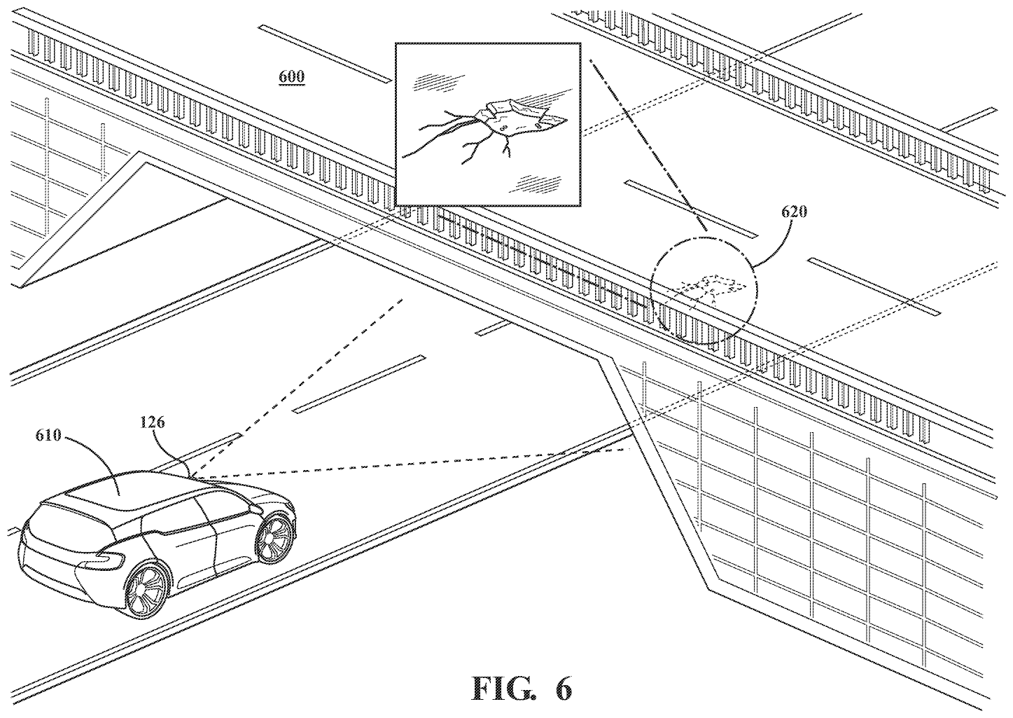

FIG. 6 illustrates an example of infrastructure that is monitored by vehicles equipped with cameras. As shown in FIG. 6, an overpass 600 carries a first road over a second road. Vehicles traverse both roads and are able to observe the overpass 600 using one or more cameras mounted thereto. A vehicle 610 progresses under the overpass, acquiring images of various elements of the infrastructure. As one example, the vehicle 610 observes a structural member of the overpass 600. The structural member includes various fatigue points, such as location 620. The infrastructure system 170 is able to process images acquired from the vehicle 610 into depth maps and analyze the depth maps to determine the location of the fatigue points. Thus, the system 170 may then further focus on these points to identify the condition of the infrastructure. As shown, the location 620 includes several cracks of a significant length and width. Thus, based on this observation, the system 170 may generate a modification to the maintenance recommendation for the overpass 600 that alerts one or more officials and provides the explicit location of the maintenance issue with recommendations for inspection and/or repair. It should be noted that the alerts may be electronically communicated to one or more devices associated with the officials responsible for the overpass 600. Moreover, the alert itself may be customized to include specific information about the overpass 600, such as the identified condition, a location (e.g., GPS location), an immediacy of the condition, a proposed resolution, and so on. In this way, the infrastructure system 170 improves monitoring and maintenance of infrastructure to avoid difficulties with deferred maintenance and inspection.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from a user (e.g., human driver). In one or more arrangements, the vehicle 100 can be a conventional vehicle that is configured to operate in only a manual mode.

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component, and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100.

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124 (e.g., 4 beam LiDAR), one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element or arrangement or groups thereof that enable information/data to be entered into a machine. The input system 130 can receive an input from a vehicle passenger (e.g., a driver or a passenger). The vehicle 100 can include an output system 135. An “output system” includes a device, or component, that enables information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the infrastructure system 170, and/or the automated driving module 160 can be operatively connected to communicate with the various vehicle systems 140 and/or individual components thereof. For example, returning to FIG. 1, the processor(s) 110 and/or the automated driving module 160 can be in communication to send and/or receive information from the various vehicle systems 140 to control the movement, speed, maneuvering, heading, direction, etc. of the vehicle 100. The processor(s) 110, the infrastructure system 170, and/or the automated driving module 160 may control some or all of these vehicle systems 140 and, thus, may be partially or fully autonomous.

The processor(s) 110, the infrastructure system 170, and/or the automated driving module 160 can be operatively connected to communicate with the various vehicle systems 140 and/or individual components thereof. For example, returning to FIG. 1, the processor(s) 110, the infrastructure system 170, and/or the automated driving module 160 can be in communication to send and/or receive information from the various vehicle systems 140 to control the movement, speed, maneuvering, heading, direction, etc. of the vehicle 100. The processor(s) 110, the infrastructure system 170, and/or the automated driving module 160 may control some or all of these vehicle systems 140.

The processor(s) 110, the infrastructure system 170, and/or the automated driving module 160 may be operable to control the navigation and/or maneuvering of the vehicle 100 by controlling one or more of the vehicle systems 140 and/or components thereof. For instance, when operating in an autonomous mode, the processor(s) 110, the infrastructure system 170, and/or the automated driving module 160 can control the direction and/or speed of the vehicle 100. The processor(s) 110, the infrastructure system 170, and/or the automated driving module 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof responsive to receiving signals or other inputs from the processor(s) 110 and/or the automated driving module 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module 160 can be configured to receive data from the sensor system 120 and/or any other type of system capable of capturing information relating to the vehicle 100 and/or the external environment of the vehicle 100. In one or more arrangements, the automated driving module 160 can use such data to generate one or more driving scene models. The automated driving module 160 can determine a position and velocity of the vehicle 100. The automated driving module 160 can determine the location of obstacles, obstacles, or other environmental features including traffic signs, trees, shrubs, neighboring vehicles, pedestrians, etc.

The automated driving module 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module 160 either independently or in combination with the infrastructure system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module 160 can be configured to implement determined driving maneuvers. The automated driving module 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the Figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a standalone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An infrastructure system, comprising:
one or more processors;
a memory communicably coupled to the one or more processors and storing instructions that, when executed by the one or more processors, cause the one or more processors to:
acquire sensor data about an infrastructure element;
generate depth maps from the sensor data using a depth model that performs monocular depth estimation;
analyze the depth maps to determine a condition of the infrastructure element;
responsive to determining that the condition satisfies a health threshold, modify a maintenance recommendation for the infrastructure element; and
provide the maintenance recommendation.

2. The infrastructure system of claim 1, wherein the instructions to acquire the sensor data include instructions to acquire monocular images from a vehicle of the infrastructure element as the vehicle traverses an area of the infrastructure element.

3. The infrastructure system of claim 1, wherein the instructions to generate the depth maps include instructions to aggregate the depth maps by using the depth model to process monocular images from multiple vehicles that separately observe the infrastructure element.

4. The infrastructure system of claim 1, wherein the instructions to analyze the depth maps include instructions to track the condition of the infrastructure element by identifying fatigue points within the infrastructure element according to at least movement shown by the depth maps in the infrastructure element and determine whether the fatigue points exhibit a degradation of the condition.

5. The infrastructure system of claim 4, wherein the instructions to identify the fatigue points include instructions to determine an extent of deflection at points on the infrastructure element, and
wherein the instructions to determine whether the fatigue points exhibit degradation include instructions to determine whether one or more cracks are present and characteristics of the cracks.

6. The infrastructure system of claim 1, wherein the instructions to determine that the condition satisfies the health threshold include instructions to determine whether the infrastructure element includes a new crack, a crack that exceeds a defined threshold, or a change in the condition since a prior observation.

7. The infrastructure system of claim 1, wherein the instructions to modify the maintenance recommendation include instructions to adjust one or more maintenance tasks for the infrastructure element according to the condition according to a large language model (LLM), and wherein the maintenance tasks include inspection and repair of the infrastructure element.

8. The infrastructure system of claim 1, wherein acquiring the sensor data includes receiving images from vehicles via a wireless connection at the infrastructure element as the vehicles traverse an area of the infrastructure element.

9. A non-transitory computer-readable medium including instructions that, when executed by one or more processors, cause the one or more processors to:
acquire sensor data about an infrastructure element;
generate depth maps from the sensor data using a depth model that performs monocular depth estimation;
analyze the depth maps to determine a condition of the infrastructure element;
responsive to determining that the condition satisfies a health threshold, modify a maintenance recommendation for the infrastructure element; and
provide the maintenance recommendation.

10. The non-transitory computer-readable medium of claim 9, wherein the instructions to acquire the sensor data include instructions to acquire monocular images from a vehicle of the infrastructure element as the vehicle traverses an area of the infrastructure element.

11. The non-transitory computer-readable medium of claim 9, wherein the instructions to generate the depth maps include instructions to aggregate the depth maps by using the depth model to process monocular images from multiple vehicles that separately observe the infrastructure element.

12. The non-transitory computer-readable medium of claim 9, wherein the instructions to analyze the depth maps include instructions to track the condition of the infrastructure element by identifying fatigue points within the infrastructure element according to at least movement shown by the depth maps in the infrastructure element and determine whether the fatigue points exhibit a degradation of the condition.

13. The non-transitory computer-readable medium of claim 12, wherein the instructions to identify the fatigue points include instructions to determine an extent of deflection at points on the infrastructure element, and
wherein the instructions to determine whether the fatigue points exhibit degradation include instructions to determine whether one or more cracks are present and characteristics of the cracks.

14. A method, comprising:
acquiring sensor data about an infrastructure element;
generating depth maps from the sensor data using a depth model that performs monocular depth estimation;
analyzing the depth maps to determine a condition of the infrastructure element;
responsive to determining that the condition satisfies a health threshold, modifying a maintenance recommendation for the infrastructure element; and
providing the maintenance recommendation.

15. The method of claim 14, wherein acquiring the sensor data includes acquiring monocular images from a vehicle of the infrastructure element as the vehicle traverses an area of the infrastructure element.

16. The method of claim 14, wherein generating the depth maps includes aggregating the depth maps by using the depth model to process monocular images from multiple vehicles that separately observe the infrastructure element.

17. The method of claim 14, wherein analyzing the depth maps includes tracking the condition of the infrastructure element by identifying fatigue points within the infrastructure element according to at least movement shown by the depth maps in the infrastructure element and determining whether the fatigue points exhibit a degradation of the condition.

18. The method of claim 17, wherein identifying the fatigue points includes determining an extent of deflection at points on the infrastructure element, and
wherein determining whether the fatigue points exhibit degradation includes determining whether one or more cracks are present and characteristics of the cracks.

19. The method of claim 14, wherein determining that the condition satisfies the health threshold includes determining whether the infrastructure element includes a new crack, a crack that exceeds a defined threshold, or a change in the condition since a prior observation.

20. The method of claim 14, wherein modifying the maintenance recommendation includes adjusting one or more maintenance tasks for the infrastructure element according to the condition according to a large language model (LLM), and wherein the maintenance tasks include inspection and repair of the infrastructure element.
